(19) United States
(12) Patent Application Publication
(10) Pub. No.: US 2024/0311183 A1
(43) Pub. Date: Sep. 19, 2024

(54) ON-DEMAND HARDWARE EVENT LOGGING USING WORK DESCRIPTORS

(71) Applicant: Mellanox Technologies, Ltd., Yokneam (IL)

(72) Inventors: Natan Manevich, Nesher (IL); Ariel Shahar, Jerusalem (IL); Wojciech Wasko, Mlynek (PL); Dotan David Levi, Kiryat Motzkin (IL); Roee Moyal, Yoqneam Ilit (IL); Eliel Peretz, Kiryat Motzkin (IL)

(21) Appl. No.: 18/479,784

(22) Filed: Oct. 2, 2023

Related U.S. Application Data
(60) Provisional application No. 63/451,902, filed on Mar. 13, 2023.

(51) Int. Cl. G06F 9/48; G06F 9/54

(52) U.S. Cl. CPC G06F 9/4881; G06F 9/542

(57) ABSTRACT

A work descriptor identifying a plurality of workflow tasks to be performed by a hardware device is generated by a host system. A plurality of timestamp logging tasks are added to the work descriptor. Each of the plurality of timestamp logging tasks corresponds to one of the plurality of workflow tasks and instructs the hardware device to log a timestamp in response to an event associated with a respective workflow task. The work descriptor with the plurality of timestamp logging tasks is stored in a work queue of the host system. The work queue is accessible by the hardware device.

### RELATED APPLICATIONS

This application claims the benefit of U.S. Provisional Patent Application No. 63/451,902, filed Mar. 13, 2023, the entirety of which is incorporated herein by reference.

### TECHNICAL FIELD

At least one embodiment pertains to processing resources used to perform and facilitate debugging, visibility, and diagnostics of hardware systems, such as logging and latency diagnostics in computing and network systems. For example, at least one embodiment pertains to on-demand hardware event logging using work descriptors, according to various novel techniques described herein.

### BACKGROUND

Within computing devices, networking devices, and other hardware devices, exposure of internal hardware information, diagnostics, and statistics remains a challenge in the hardware industry. Such information is employed to understand the internal behavior and processes running on the hardware and provides valuable information that may be utilized to debug and stabilize hardware performance. Several approaches to exposing internal diagnostics and statistics exist, such as event logging techniques. Event logging techniques generally allow configuration of targeted events to be captured using filtering options (e.g., filtering profiles), but these configurations may not be granular enough to target a subset of workloads triggering the targeted events.

### BRIEF DESCRIPTION OF DRAWINGS

Various embodiments in accordance with the present disclosure will be described with reference to the drawings, in which:

FIG. 1 is a block diagram illustrating a system comprising a host and a hardware device, according to at least one embodiment.

FIG. 2A illustrates an example traceable work descriptor used for hardware event logging, according to at least one embodiment.

FIG. 2B illustrates an example traceable work descriptor used for hardware event logging, according to at least one embodiment.

FIG. 2C illustrates an example traceable work descriptor used for hardware event logging, according to at least one embodiment.

FIG. 3 illustrates an example timestamp log recorded in response to a hardware event, according to at least one embodiment.

FIG. 4 is a flow diagram of a method for on-demand hardware event logging using traceable work descriptors, according to at least one embodiment.

FIG. 5 is a flow diagram of a method for on-demand hardware event logging using traceable work descriptors, according to at least one embodiment.

FIG. 6 is a sequence diagram of a hardware event logging sequence, according to at least one embodiment.

FIG. 7 is a block diagram illustrating a computer system, according to at least one embodiment.

### DETAILED DESCRIPTION

Exposure of internal hardware information, diagnostics, and statistics is increasingly challenging in the hardware industry. As described above, some approaches to exposing internal diagnostics and statistics exist, such as event logging techniques. Event logging is a mechanism that records in a log (e.g., a file) diagnostic data related to various events that occur in a hardware system. For example, in the case of packets sent on a network port, the diagnostic data may include port number, packet length, packet priority, work queue of the packet, transmission time, and the like. Event logging techniques generally allow configuration of targeted events to be captured using filtering options (e.g., filtering profiles), but these configurations may not be granular enough to target a subset of workloads triggering the targeted events. Thus, event logging often results in the capture of all events that meet a specific filtering profile for all workloads, and an excessive number of irrelevant events may overwhelm the system, consume too much bandwidth or storage, or make the task of manually sorting through logs exceedingly difficult. Accordingly, processing of all the events provided by a specific filtering profile in real-time becomes unfeasible. Furthermore, event logging techniques may rely on external tools and processes, such as external debuggers, to log events that occur in the operating system, software, and/or hardware systems. Reliance on these external tools and processes limit the ability of a system to decide in real-time (e.g., “on demand”) whether to log, and can be the source of unnecessary integration challenges for system architects and engineers. For example, in order to initiate event logging, a system may have to stop sending new work to the target and request an external tool to enable event logging. The system may have to wait for confirmation from the external tool that event logging is enabled before resuming sending new work to the target. This process can introduce excessive latency in the normal workflow.

Aspects of the present disclosure address the above and other deficiencies by providing techniques and methods for modifying existing work descriptors to include on-demand hardware event logging tasks. A work descriptor refers to an agreed-upon form of communication between a host system and a hardware device that enables the host to specify work for the hardware to perform. In some implementations, a host system generates a work descriptor to instruct a hardware device to perform a workflow task or a series of workflow tasks (e.g., deliver a packet over a network interface). The hardware device accesses the work descriptor and performs associated workflow tasks by initiating a series of hardware events associated with each workflow task. For example, hardware events associated with a workflow task for delivering a packet may include: (i) fetching the packet data from (a memory of) the host system, (ii) storing the packet data in local memory of the hardware device, (iii) attaching a packet header to the packet data, and (iv) sending the packet to the network interface of the hardware device.

The hardware device may be a network interface controller (NIC), a graphics processing unit (GPU), a data processing unit (DPU), or a central processing unit (CPU). A work descriptor may refer to a construct (e.g., a data structure) that follows a predefined format and enables the host system and the hardware device to communicate with each other. Each work descriptor may specify one or more tasks (e.g., workflow task(s)) to be executed by the hardware device.

In some embodiments, a work descriptor may initially specify tasks of a certain type (e.g., workflow tasks) and may be subsequently modified to specify tasks of another type (e.g., timestamp logging tasks) to enable on-demand hardware event logging. The timestamp logging tasks may include a work descriptor timestamp logging task and workflow timestamp logging tasks. The timestamp logging tasks may include logging progress statuses for various hardware tasks (e.g., data transfer initiated, data transfer complete), progress of the work descriptor or workflow task itself (e.g., work descriptor complete, workflow task complete), one or more operations associated with a hardware peripheral (e.g., packet sent or packet received at network interface), breakpoints, checkpoints, errors, or other information in various embodiments.

The work descriptor timestamp logging task may enable (e.g., via a logging activation request) hardware event logging for a specific work descriptor. In at least one embodiment, upon completion of each workflow task of the work descriptor, a timestamp indicating a time a respective workflow task of the work descriptor was completed is obtained and assigned to the respective workflow task. To assign the timestamp to the respective workflow task, a unique identifier may be generated for each respective workflow task. The unique identifier may be associated with a specific instance of the respective workflow task to distinguish between different instances of the respective workflow task included in the same work descriptor or in different work descriptors of the work queue. Accordingly, the unique identifier referencing the specific instance of the respective workflow task may be coupled with a timestamp to indicate that the respective workflow task was completed at the time associated with the timestamp. Similarly, an event label may be generated to assign the timestamp to the specific hardware event that triggered it in at least one embodiment. Unique identifiers and event labels may be useful to aid in identifying timestamps in situations where workflow tasks and/or hardware events may execute in parallel or trigger out of order.

The host system may periodically include one or more timestamp logging tasks in a work descriptor to obtain latency-related statistical information associated with the hardware device. In at least one embodiment, one or more timestamp logging tasks may be added to work descriptors associated with a specific operation at a predetermined frequency to identify latency-related statistical information associated with a specific operation of the hardware device. In at least one embodiment, one or more timestamp logging tasks may be added to work descriptors not associated with a specific operation at a predetermined frequency to identify latency related statistical information associated with the hardware device.

When creating the work descriptor to perform a specific operation on the hardware device, the host system may include one or more timestamp logging tasks and one or more workflow tasks. The work descriptor with one or more timestamp logging tasks may also be referred to as a traceable work descriptor. In at least one embodiment, the work descriptor may specify, in order, a work descriptor timestamp logging task and workflow tasks. In at least one embodiment, the work descriptor may specify, in order, one or more timestamp logging tasks associated with one or more of the workflow tasks, and the workflow tasks. In at least one embodiment, the work descriptor may specify, in order, workflow tasks and a work descriptor timestamp logging task. In at least one embodiment, the work descriptor may specify, in order, workflow tasks and one or more workflow timestamp logging tasks associated with one or more of the workflow tasks. In at least one embodiment, the work descriptor may specify one or more work descriptor type fields to aid the hardware device in decoding the timestamp logging tasks and/or the workflow tasks.

In at least one embodiment, the generated work descriptor is stored in a work queue of the host system. The hardware device can be notified that a pending generated work descriptor is stored in the work queue, and access to the work descriptor in the work queue may be provided to the hardware device. Access may be provided via an application programming interface. The hardware device can retrieve (e.g., access) the work descriptor in the work queue of the host system and parse or decode the work descriptor. For example, the hardware device may determine that the work descriptor includes one or more timestamp logging tasks (e.g., a work descriptor timestamp logging task or one or more workflow timestamp logging tasks), identify one or more workflow tasks associated with performing a specific operation, and then perform each workflow task by initiating a series of hardware events.

In at least one embodiment, upon completion of each respective workflow task, a timestamp or a group of timestamps (and unique identifiers and/or event labels if applicable) associated with the respective workflow task can be recorded, by the hardware device, to a log. In at least one embodiment, a group of timestamps may be maintained by the hardware device in local memory of the hardware device and recorded group by group to a log. The log can be subsequently provided, by the hardware device, to the host system upon completion of the tasks specified in the work descriptor. In at least one embodiment, the log is stored on the host system and access is provided to the hardware device to record the timestamp log(s) associated with the respective work descriptor. In at least one embodiment, the timestamp log(s) associated with the respective work descriptor is provided directly to the host system.

Aspects of the present disclosure provide various advantages, including but not limited to improving the granularity and case of integration of logging events on hardware devices and improving utilization of bandwidth and storage available for logging use. In at least one embodiment, the present disclosure provides a real-time high-speed response to activation of logging requests by modifying work descriptors to include logging tasks to be performed by the hardware device. Thus, the host is not required to interrupt the normal workflow to activate an external debugging tool, which may reduce latency and interruptions to the normal workflow associated with the external tool. Other advantages will be apparent to those skilled in the art of intelligent systems and devices discussed hereinafter.

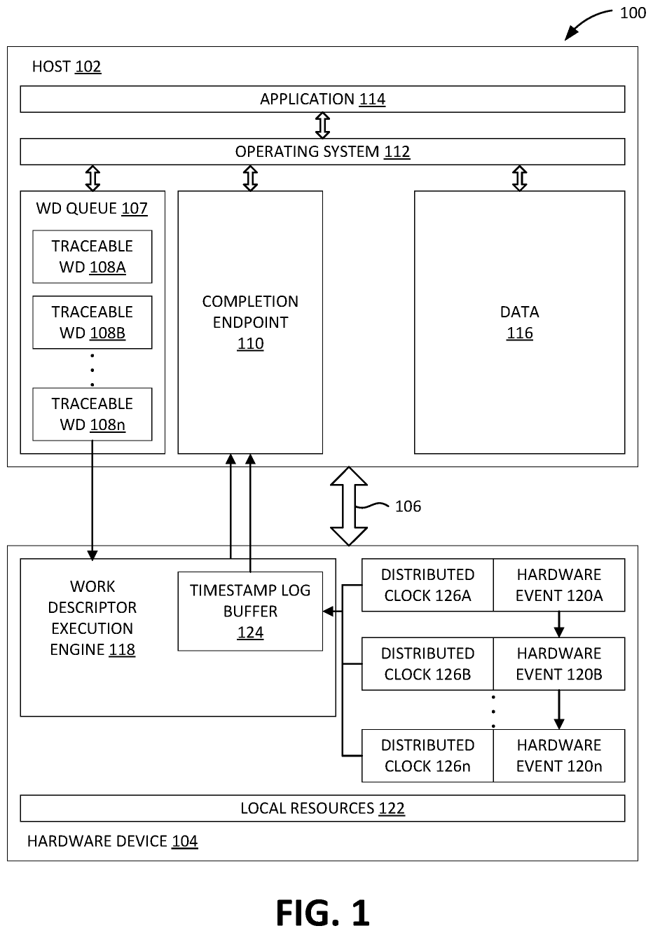

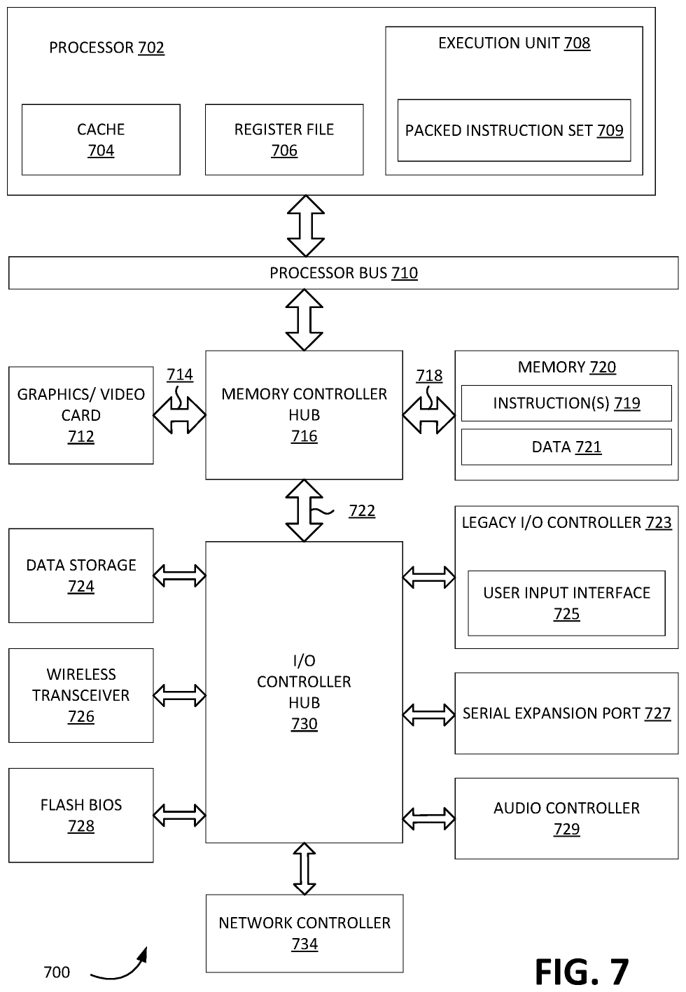

FIG. 1 illustrates a system 100 comprising a host 102 and a hardware device 104 in accordance with at least one embodiment. In at least one embodiment, host 102 is a computer system and may comprise a central processing unit (CPU), random-access memory (RAM), data storage, input/output peripherals, and other components. An example computer system is described in further detail with respect to FIG. 7. Hardware device 104 may be another computer system, a central processing unit, a graphics processing unit (GPU), a data processing unit (DPU), a network interface controller (NIC), or other peripheral. Host 102 and hardware device 104 are connected by communication channel 106. Communication channel 106 may comprise any networking, switching, or other communication protocols and buses alone or in combination, such as PCIe, NVIDIA NVLINK, InfiniBand, Ethernet, Fibre Channel, a cellular or wireless communication network, a ground referenced signaling (GRS) link, the Internet, combinations thereof (e.g., Fibre Channel over Ethernet), or variants thereof, for example.

In at least one embodiment, system 100 corresponds to one or more of a personal computer (PC), a laptop, a workstation, a tablet, a smartphone, a server, a collection of servers, a data center, or the like. In at least one embodiment, host 102 and hardware device 104 are discrete components that comprise system 100. In at least one embodiment, host 102, hardware device 104, and communication channel 106 are part of a monolithic system 100, such as a system-on-chip (SoC).

In at least one embodiment, host 102 comprises a work descriptor queue 107 of traceable work descriptors 108A-n and a completion endpoint 110. Host 102 may further comprise an operating system (OS) 112, an application 114, and data 116 associated with application 114. OS 112 may mediate between application 114 and any of hardware device 104, work descriptor queue 107, completion endpoint 110, or data 116. OS mediation may be accomplished via drivers, libraries, kernel modules, application programming interfaces (APIs), or similar. In at least one embodiment, OS 112 may be absent and the application may directly communicate with any of hardware device 104, work descriptor queue 107, completion endpoint 110, or data 116 without OS mediation. In at least one embodiment, host 102 and application 114 are synonymous (e.g., an application container), and application 114 manages work descriptor queue 107, completion endpoint 110, and data 116, as well as communication with hardware device 104. In at least one embodiment, OS 112 and application 114 are synonymous (e.g., a kernel module or driver is the application). Various embodiments may utilize any combination of the above host architectures and communication methods.

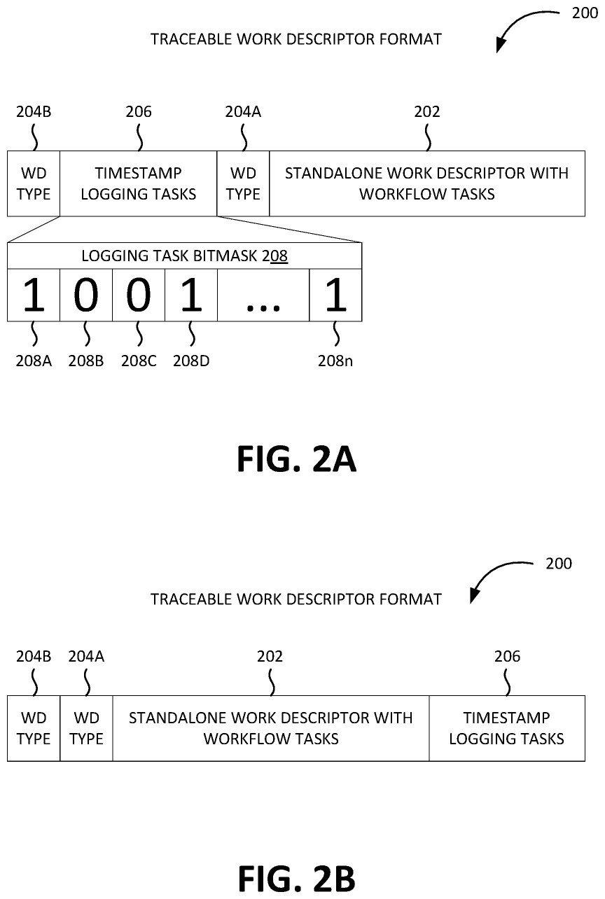

Work descriptor queue 107 may be a section of memory, a buffer, a file, or other storage solution for maintaining a queue of work descriptors. Traceable work descriptors 108A-n may be constructs that specify one or more workflow tasks to be completed by hardware device 104, each workflow task comprising one or more events that occur on hardware device 104. Work descriptor queue 107 may hold a mix of standalone work descriptors and traceable work descriptors, examples of which are further described with respect to FIGS. 2A-C. In at least one embodiment, work descriptor queue 107 is loaded with new work descriptors by OS 112 or application 114, and work descriptors are unloaded from work descriptor queue 107 by hardware device 104. In at least one embodiment, work descriptor queue 107 is unloaded by the host and the work descriptors are sent to hardware device 104. In at least one embodiment, multiple work descriptors queues 107 are present on host 102 and are serviced by one or more hardware devices 104.

Completion endpoint 110 can enable communication from hardware device 104 to host 102 regarding work descriptors issued from work descriptor queue 107. Completion endpoint 110 may be a return value from a function or API, a synchronous or asynchronous callback, a message-passing system (e.g., pipes, FIFOs, or similar inter-process communication), a block or character device, a hardware interrupt, a section of shared memory or memory-mapped I/O (e.g., observed by host 102 via polling, interrupt, or direct memory access), or similar technique. Completion endpoint 110 may also receive communications from hardware device 104 related to traceable work descriptors and timestamp logs in at least one embodiment.

In at least one embodiment, hardware device 104 comprises a work descriptor execution engine 118, one or more hardware events 120A-n, and local resources 122. Work descriptor execution engine 118 may be implemented as a processor, a state machine, software, or any other implementation capable of performing the functions described herein. In at least one embodiment, work descriptor execution engine 118 fetches or receives a new work descriptor from host 102, such as from work descriptor queue 107. Work descriptor execution engine 118 decodes the work descriptor to determine one or more workflow tasks to execute (an example format of a work descriptor is described in more detail with respect to FIGS. 2A-C). At the completion of the workflow tasks (e.g., all workflow tasks) associated with the work descriptor, work descriptor execution engine 118 may notify host 102 via completion endpoint 110, including returning any results associated with the work descriptor if applicable. In at least one embodiment, work descriptor execution engine 118 sends multiple notifications to host 102 via completion endpoint 110 for a single work descriptor, such as at the completion of each workflow task of the work descriptor.

For each workflow task, the work descriptor execution engine initiates one or more hardware events 120A-n to perform the workflow task. Not all hardware events 120A-n may be relevant to each workflow task, and thus a limited subset of hardware events 120A-n may be active for a given workflow task. Some workflow tasks may utilize a subset of hardware events 120A-n multiple times, such as in a looping or recursive workflow task. Each hardware event may comprise dedicated logic or resources, such as a local processor, memory, state machine, or software, for example. Hardware events may be associated with an initiation, progress status, error status, or completion of a workflow task or stage of a workflow task. Hardware events may be associated with a breakpoint and thus act as a debugging tool or assist an external debugging tool.

Hardware events may also be associated with one or more local resources 122. Local resources 122 may include additional processors or memory, input/output peripherals (e.g., network interface or graphical output), or other dedicated hardware (e.g., encoders/decoders, CRC checker). Local resources 122 may also provide hardware events with access to the host via communication channel 106. For example, a hardware event may involve fetching data from data 116, which may be mediated by OS 112 or application 114, or which may be accomplished via direct memory access (DMA) or similar techniques. Hardware events may be associated with a progress status of one or more local resources 122 (e.g., initiate, complete, early-stop, error). In at least one embodiment, each local resource is associated with a single hardware event (e.g., a CRC checker resource may be associated with an CRC hardware event and not other hardware events). In at least one embodiment, a local resource may be shared among multiple hardware events (e.g., a network interface resource may be associated with a packet-received hardware event and a packet-sent hardware event, or communication channel 106 may be associated with an initiate-data-fetch hardware event and a data-fetch-complete hardware event).

Hardware device 104 further includes a timestamp log buffer 124 and one or more clocks (e.g., real-time clocks), such as distributed clocks 126A-n in at least one embodiment, to enable traceable work descriptors. A traceable work descriptor (further described herein with respect to FIGS. 2A-C) may instruct hardware device 104 to record a timestamp log associated with each of hardware events 120A-n when each hardware event is executed. Hardware device 104 may determine the time that a hardware event executed using the one or more clocks. In at least one embodiment, a clock infrastructure of distributed clocks 126A-n provides a distributed clock for each hardware event 120A-n, where each distributed clock is spatially proximal to its associated hardware event to provide accurate timing for each hardware event. For example, one of distributed clocks 126A-n may be proximal to an I/O port of the hardware device such that the clock can accurately record a timestamp log for, e.g., the transmission time at which a network packet went into the wire. The clock infrastructure manages synchronization of distributed clocks 126A-n. In at least one embodiment, a single global clock is used to report the time for all hardware events 120A-n (not shown). A mixture of the two architectures is present in at least one embodiment, where some hardware events share a clock and some hardware events have a dedicated clock.

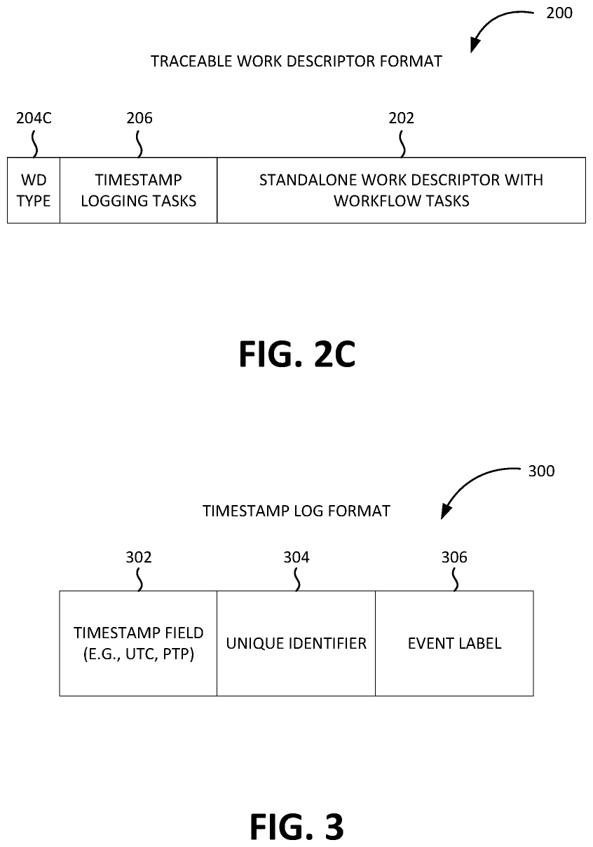

When a hardware event is executed, the time is recorded from the appropriate clock and placed in timestamp log buffer 124 as a timestamp log. An example format of a timestamp log is described herein with respect to FIG. 3. Timestamp log buffer 124 may be a section of memory, a buffer, a file, or other storage solution for maintaining a collection of timestamp logs. Hardware device 104 may send the timestamp logs to host 102 via completion endpoint 110 at the completion of the associated traceable work descriptor, at the completion of each workflow task, or at another interval as appropriate. Timestamp logs may be sent individually or may be grouped by event, workflow task, work descriptor, or other grouping scheme as appropriate. In at least one embodiment, hardware device 104 sends the timestamp logs to host 102 via communication channel 106, such as via direct memory access. In at least one embodiment, hardware device 104 maintains timestamp log buffer 124 until the timestamp logs are requested by host 102. In at least one embodiment, timestamp log buffer 124 is absent and hardware device 104 sends timestamp logs directly to host 102 as they are issued.

FIGS. 2A-C illustrate examples of a traceable work descriptor 200 used for hardware event logging in accordance with one or more aspects of the present disclosure. Referring to FIG. 2A, traceable work descriptor 200 includes a standalone work descriptor 202 and accompanying work descriptor type field 204A. In at least one embodiment, standalone work descriptor 202 instructs hardware device 104 to perform one or more workflow tasks comprising one or more hardware events. Accompanying work descriptor type field 204A informs hardware device 104 about the format or contents of standalone work descriptor 202. Work descriptor type field 204A may be fixed-length (e.g., n bits) or variable-length, and may be encoded as a binary sequence, an integer, a string, or any other data type as appropriate. For example, upon receiving a new work descriptor, hardware device 104 may read the first n bits to determine based on work descriptor type field 204A that the new work descriptor is a send-packet work descriptor. Hardware device 104 may then proceed to read the remainder of standalone work descriptor 202 to determine data storage locations, packet destination addresses, and other information as determined by the expected format associated with work descriptor type field 204A. Standalone work descriptor 202 may encompass a single workflow task (e.g., send data A to address A) or may comprise multiple workflow tasks (e.g., send data A . . . B to addresses A . . . B). As described herein with respect to FIG. 1, each workflow task may comprise one or more hardware events associated with hardware device 104 (e.g., fetch data, attach packet header, send packet).

In at least one embodiment, standalone work descriptor 202 and accompanying work descriptor type field 204A is extended to provide traceable work descriptor 200 described herein. Traceable work descriptor 200 may further include an additional work descriptor type field 204B and timestamp logging tasks field 206. Additional work descriptor type field 204B may follow the same format as work descriptor type field 204A accompanying standalone work descriptor 202 (e.g., n bits fixed-length), and may include a unique value to inform hardware device 104 that the present work descriptor is an extended traceable work descriptor. In response to receiving a new work descriptor with leading work descriptor type field 204B indicating that the present work descriptor is a traceable work descriptor, hardware device 104 may proceed to read timestamp logging tasks field 206 and then decode second work descriptor type field 204A and standalone work descriptor 202 as described above to determine the workflow tasks. This traceable work descriptor format is advantageous for the host because existing work descriptors can be converted to traceable work descriptors by prepending timestamp logging tasks field 206 and additional work descriptor type field 204B, with no need to modify the format or content of the original work descriptors. Furthermore, the same decoding hardware can be utilized on hardware device 104 for decoding both work descriptor type fields 204A-B.

Timestamp logging tasks field 206 of traceable work descriptor 200 may be used to instruct hardware device 104 to log timestamps associated with select hardware events as hardware device 104 executes the workflow task(s) of standalone work descriptor 202. Timestamp logging tasks field 206 may comprise a logging task bitmask 208. Bits 208A-n of the bitmask may each correspond to one or more hardware events that may be logged by hardware device 104, and activating a bit in the bitmask (e.g., setting it to 1) may indicate that hardware device 104 should log a timestamp for the associated hardware event(s). The length of logging task bitmask 208 and correspondence between bits and hardware events may vary for different standalone work descriptors 202 that have different activated hardware events, or logging task bitmask 208 may be consistent for all work descriptors and encompass all possible hardware events to be logged. Not all bits may be applicable for a given work descriptor in the latter case. For example, in a copy-data work descriptor, an attach-packet-header event may not be activated, and hardware device 104 may ignore the corresponding bit as a result.

In at least one embodiment, a single bit may correspond to multiple hardware events (e.g., log all events related to data movement). In at least one embodiment, some bits of logging task bitmask 208 may be mutually exclusive or have compound meaning, inducing hardware device 104 to apply additional logic to determine the hardware events to log. In at least one embodiment, timestamp logging tasks field 206 comprises additional fields related to timestamp logging. For example, an additional field may be used to instruct the hardware device to perform logging for a subset (rather than all) of workflow tasks associated with standalone work descriptor 202 (e.g., every 10 workflow tasks), or an additional field may be used to instruct the hardware device to perform identical logging operations for subsequent work descriptors. Additional fields may also comprise additional logging task bitmasks similar to logging task bitmask 208, each bitmask corresponding to a subset of workflow tasks of the work descriptor. In at least one embodiment, timestamp logging tasks field 206 stores timestamp logging tasks using a format other than a bitmask. For example, an array or list of fixed- or variable-width timestamp logging tasks may be used.

Referring to FIG. 2B, the fields of traceable work descriptor 200 may be ordered differently or omitted in embodiments as appropriate in each application. In at least one embodiment, work descriptor type field 204B indicating a traceable work descriptor is immediately followed by second work descriptor type field 204A and accompanying standalone work descriptor 202, with timestamp logging tasks field 206 appended to the end of traceable work descriptor 200. In at least one embodiment, timestamp logging tasks field 206 is absent (not shown). Hardware device 104 may default to logging all possible timestamp logging tasks, or the timestamp logging tasks may be otherwise inherent in the standalone work descriptor. In at least one embodiment, a traceable work descriptor 200 defines timestamp logging tasks to be applied to subsequent work descriptors. Thus, the subsequent work descriptors would not require timestamp logging tasks field 206 or additional work descriptor type field 204B. In at least one embodiment, traceable work descriptor 200 includes additional fields not depicted in FIGS. 2A-C.

Referring to FIG. 2C, a traceable work descriptor 200 includes a single work descriptor type field 204C in place of work descriptor type fields 204A-B in at least one embodiment. Work descriptor type field 204C may simultaneously indicate the work descriptor type of standalone work descriptor 202 and that the present work descriptor is a traceable work descriptor as well. Thus, there may be up to 2n work descriptor type codes for n work descriptor types (potentially traceable and non-traceable versions of each type) in at least one embodiment. Not all work descriptors may be traceable in some embodiments.

FIG. 3 illustrates an example timestamp log 300 that is recorded in response to a hardware event associated with a workflow task on hardware device 104 in at least one embodiment. Timestamp log 300 includes a timestamp field 302, a unique identifier 304, and an event label 306. These fields may be encoded and stored as text (e.g., ASCII or UTF-8 encoding), integers, floating-point numbers, binary encoding, or other data type as appropriate for the application.

Timestamp field 302 may be used to record a time at which a hardware event occurs on hardware device 104. Various formats and timekeeping methods may be used, such as Coordinated Universal Time (UTC), Precision Time Protocol (PTP), free-running counters, clock cycle counters, Unix time (seconds since the Unix epoch), etc. As described with respect to FIG. 1, the time may be measured from a global clock source on hardware device 104, from a local clock source spatially proximal to the hardware event and synchronized with a distributed clock system, or other clock distribution method as appropriate.

Unique identifier 304 may be used to associate timestamp log 300 with a workflow task of traceable work descriptor 200 during later log analysis and may distinguish the log from other timestamp logs associated with other workflow tasks that may be interspersed in the same collection of timestamp logs. Unique identifier 304 may be generated by host system 102 and associated with a workflow task before queueing traceable work descriptor 200. Unique identifier 304 may also be generated on-the-fly and later associated with the workflow task via, e.g., a database, completion endpoint 110, or similar.

Event label 306 may be associated with a class of hardware event or events (e.g., fetching data, attaching a packet header) and may associate timestamp log 300 with the hardware event that triggered the logging activity. Event label 306 may be, for example, a single value associated with a hardware event, providing a more compact representation. Event label 306 may also be a bitmask similar to logging task bitmask 208 of traceable work descriptor 200. A bitmask event label can provide a one-to-one correspondence between hardware events and logs and may also provide the advantage of associating a single timestamp log with multiple simultaneous hardware events.

In at least one embodiment, timestamp log 300 consists of timestamp field 302 (e.g., and not other fields), and the log analyst (e.g., human or software) relies on the order of timestamps to determine which hardware event corresponds to which timestamp. A compact timestamp log such as this may be advantageous in situations where workflow tasks and hardware events are guaranteed to occur in order, and further where the logging facilities benefit from reduced log size or smaller bandwidth requirements. Similarly, a timestamp log in at least one embodiment may be limited to one of unique identifier 304 or event label 306 in order to reduce log size when the other field is superfluous. In at least one embodiment, the timestamp log includes additional fields as required by the application.

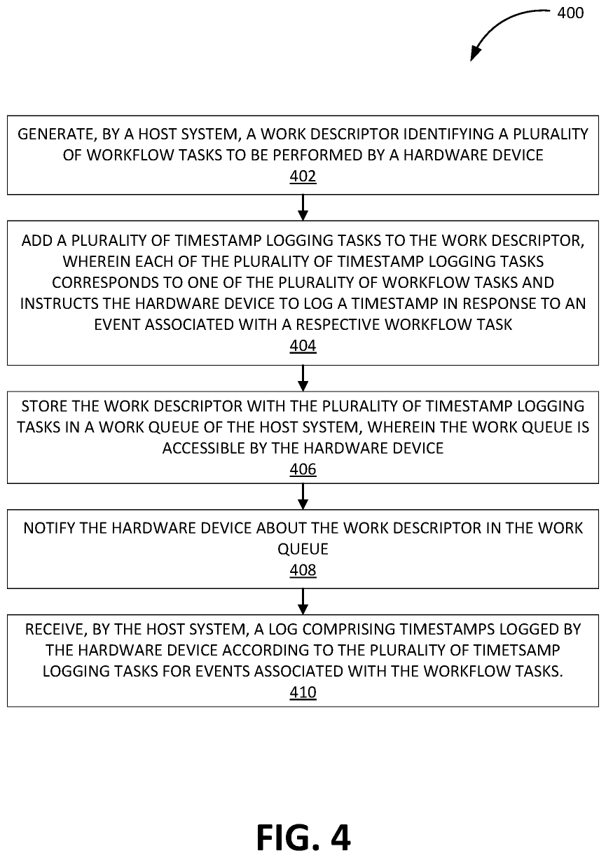

FIG. 4 depicts a flow diagram of an example method 400 for on-demand hardware event logging using traceable work descriptors, in accordance with one or more aspects of the present disclosure. The method may be performed by processing logic that may comprise hardware (circuitry, dedicated logic, etc.), computer readable instructions such as software or firmware (run on a general-purpose computing system or a dedicated machine), or a combination of both. In an illustrative example, method 400 may be performed by computer system 700 of FIG. 7. Alternatively, some or all of method 400 might be performed by another module or machine. In at least one embodiment, method 400 is performed by host 102 or components thereof (e.g., OS 112 or application 114). It should be noted that blocks depicted in FIG. 4 could be performed simultaneously or in a different order than that depicted. Embodiments may include additional blocks not depicted in FIG. 4 or a subset of blocks depicted in FIG. 4.

At block 402, processing logic of a host system generates a work descriptor identifying a plurality of workflow tasks to be performed by a hardware device. The host system is host 102 in at least one embodiment, and the work descriptor may be generated by application 114, OS 112, or some other component in communication with host 102. The work descriptor is standalone work descriptor 202 with accompanying work descriptor type field 204A of FIGS. 2A-B in at least one embodiment. The host system may generate the work descriptor by determining the type of workflow tasks desired, setting an appropriate work descriptor type field, and then specifying one or more workflow tasks of that type to comprise the full work descriptor. In at least one embodiment, the workflow tasks may be of different types. The hardware device is hardware device 104 of FIG. 1 in at least one embodiment.

At block 404, the processing logic adds a plurality of timestamp logging tasks to the work descriptor, wherein each of the plurality of timestamp logging tasks corresponds to one of the plurality of workflow tasks and instructs the hardware device to log a timestamp in response to an event associated with a respective workflow task. As described herein with respect to FIG. 1, the event associated with the respective workflow task may be one of a breakpoint event, an initiation event of a stage of the respective workflow task, a completion event of the stage of the respective workflow task, a completion event of the respective workflow task, or other relevant event.

In at least one embodiment, the plurality of timestamp logging tasks is added to the work descriptor to create a traceable work descriptor (e.g., traceable work descriptor 200 as described with respect to FIGS. 2A-C). The timestamp logging tasks may be added by prepending additional work descriptor type field 204B and timestamp logging tasks field 206 and setting the appropriate bits in logging task bitmask 208 corresponding to the desired timestamp logging tasks. As described with respect to FIG. 2C, the work descriptor may be restructured to accommodate the timestamp logging tasks, such as by changing original work descriptor type field 204A to work descriptor type field 204C. Bits 208A-n of logging task bitmask 208, if set, may instruct hardware device 104 to log a timestamp in response to hardware events 120A-n for the affected workflow task(s).

Each timestamp logging task (e.g., as represented by a set bit in logging task bitmask 208) may apply to one or more of the workflow tasks of the work descriptor. For example, in a work descriptor of mixed workflow task types, a timestamp logging task may apply to one type (e.g., and not other types) of workflow task. In a work descriptor containing additional timestamp logging task fields directing the hardware device to log for select workflow tasks (e.g., every 10 workflow tasks), a timestamp logging task may apply to those select workflow tasks (e.g., and not other workflow tasks). In a work descriptor containing uniform workflow tasks and no additional directives, a timestamp logging task may apply to each workflow task. In at least one embodiment, the processing logic associates each timestamp logging task with a respective workflow task based on user input. For example, a user may direct the processing logic via a debugging interface to associate a timestamp logging task with every 10 workflow tasks.

In at least one embodiment, each of the plurality of timestamp logging tasks further instructs the hardware device to record, in response to the event associated with the respective workflow task, a unique identifier associated with the respective workflow task to a log (e.g., unique identifier 304). The timestamp logging tasks may also instruct the hardware device to record an event label associated with the event to a log (e.g., event label 306). A combination of these fields or additional fields may also be logged.

In at least one embodiment, adding the plurality of timestamp logging tasks to the work descriptor is responsive to a logging activation request associated with each timestamp logging task of the plurality of timestamp logging tasks. The logging activation request may reflect an instruction to be performed by the hardware device to log the timestamp in response to the event associated with the respective workflow task instead of a default timestamp. For example, the hardware device may by default log a timestamp (e.g., via completion endpoint 110) at the end of each workflow task or work descriptor as part of normal operation and switch to the more granular event-based timestamp logs dictated by the timestamp logging tasks in response to the activation request. The logging activation request may originate from application 114, a debugging interface, or another source.

At block 406, the processing logic stores the work descriptor with the plurality of timestamp logging tasks in a work queue of the host system, wherein the work queue is accessible by the hardware device. The work queue of the host system is work descriptor queue 107 in at least one embodiment. The processing logic may store the work descriptor in the queue by calling a function or API (e.g., associated with driver or library), writing to a section of memory or memory-mapped I/O (e.g., using direct memory access), sending a message via a network interface or message-passing system, or similar technique. Likewise, the work queue may be accessible to the hardware device using these or other techniques (e.g., via communication channel 106).

At block 408, the processing logic notifies the hardware device about the work descriptor in the work queue. The processing logic may use any of the techniques described herein or similar techniques to notify the hardware device in at least one embodiment (e.g., using an API, communicating via communication channel 106). In at least one embodiment, the hardware device may self-notify by observing changes to the contents of the work queue, thus not requiring additional action from the processing logic to notify the hardware device after storing the work descriptor in the work queue. The hardware device may access the work descriptor in the work queue upon receiving a notification.

At block 410, the processing logic receives a log comprising timestamps logged by the hardware device according to the plurality of timestamp logging tasks for events associated with the workflow tasks. The log is the contents of timestamp log buffer 124 in at least one embodiment. The log may be received from the hardware device using completion endpoint 110 or other techniques described with respect to FIG. 1 herein. In at least one embodiment, the timestamps logged by the hardware device according to the plurality of timestamp logging tasks for events associated with workflow tasks are grouped based on the work descriptor. The timestamp logs may also be grouped by workflow task, event, or other grouping scheme.

In at least one embodiment, the processing logic periodically uses a plurality of timestamps logged by the hardware device to obtain latency related statistical information of the hardware device. For example, the processing logic may periodically generate traceable work descriptors and perform statistical analyses on the received timestamp logs to analyze trends related to latency of work descriptors, workflow tasks, hardware events, local resources, or other metrics.

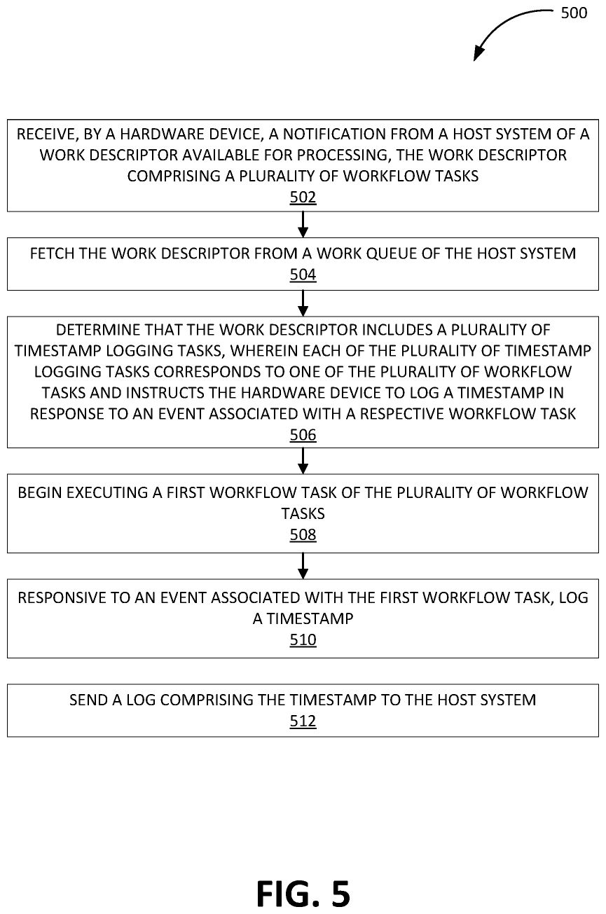

FIG. 5 depicts a flow diagram of an example method 500 for on-demand hardware event logging using traceable work descriptors, in accordance with one or more aspects of the present disclosure. The method may be performed by processing logic that may comprise hardware (circuitry, dedicated logic, etc.), computer readable instructions such as software or firmware (run on a general-purpose computing system or a dedicated machine), or a combination of both. In an illustrative example, method 500 may be performed by computer system 700 of FIG. 7. Alternatively, some or all of method 500 might be performed by another module or machine. In at least one embodiment, method 500 is performed by hardware device 104 or components thereof (e.g., work descriptor execution engine 118). It should be noted that blocks depicted in FIG. 5 could be performed simultaneously or in a different order than that depicted. Embodiments may include additional blocks not depicted in FIG. 5 or a subset of blocks depicted in FIG. 5.

At block 502, processing logic of a hardware device receives a notification from a host system of a work descriptor available for processing, the work descriptor comprising a plurality of workflow tasks. In at least one embodiment, the host system is host 102, and the hardware device is hardware device 104. The notification may be transmitted as described with respect to FIG. 4.

At block 504, the processing logic fetches the work descriptor from a work queue of the host system. In at least one embodiment, the work queue is work descriptor queue 107. The work descriptor may be fetched via communication channel 106 using direct memory access, a function or API call, a network interface, a message-passing system, or similar technique.

At block 506, the processing logic determines that the work descriptor includes a plurality of timestamp logging tasks, wherein each of the plurality of timestamp logging tasks corresponds to one of the plurality of workflow tasks and instructs the hardware device to log a timestamp in response to an event associated with a respective workflow task. In at least one embodiment, the processing logic decodes a work descriptor type field (e.g., work descriptor type field 204B or 204C) to determine that the work descriptor includes a plurality of timestamp logging tasks. Each timestamp logging task may correspond to a workflow task in various manners as described herein with respect to FIG. 2. In at least one embodiment, the determining may be done by work descriptor execution engine 118.

At block 508, the processing logic begins executing a first workflow task of the plurality of workflow tasks. In at least one embodiment, the work descriptor execution engine 118 begins executing the first workflow task.

At block 510, the processing logic, responsive to an event associated with the first workflow task, logs a timestamp. In at least one embodiment, the even associated with the first workflow task is one of hardware events 120A-n. To log a timestamp, the processing logic may determine a time from a clock source (e.g., one of distributed clocks 126A-n) and generate a timestamp log (e.g., conforming to the format of timestamp log 300). The processing logic may also place the timestamp log in timestamp log buffer 124.

At block 512, the processing logic sends a log comprising the timestamp to the host system. The log is the contents of timestamp log buffer 124 in at least one embodiment. The log may be sent to the host system using completion endpoint 110 or other techniques described with respect to FIG. 1 herein.

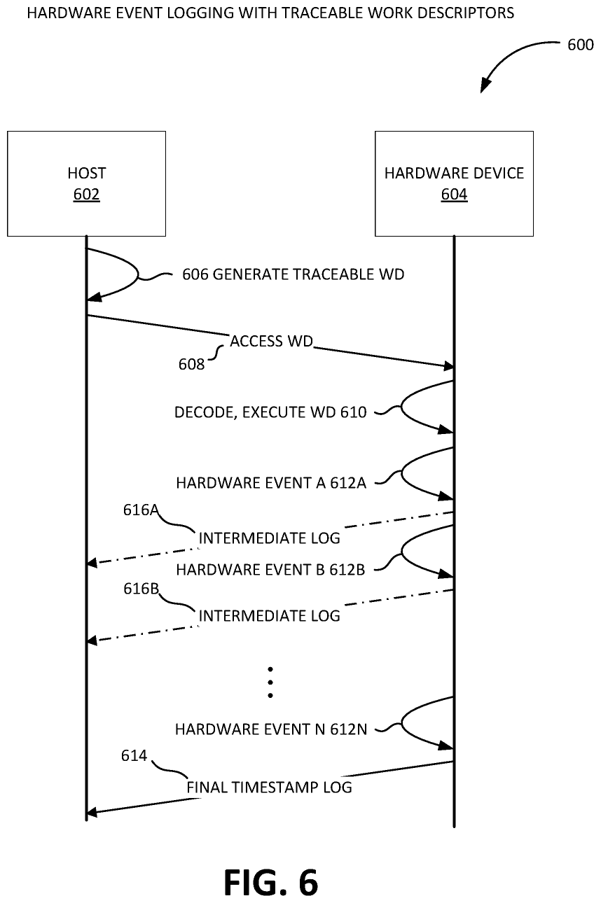

FIG. 6 depicts a sequence diagram of a hardware event logging sequence, according to at least one embodiment. The hardware event logging sequence 600 shows the flow of data and operations between a host 602 and a hardware device 604. In at least one embodiment, host 602 is host 102 of FIG. 1. In at least one embodiment, hardware device 604 is hardware device 104 of FIG. 1. The host 602 generates a traceable work descriptor at 606 using the techniques described herein. In an example scenario, the traceable work descriptor comprises a plurality of first tasks and a plurality of second tasks, wherein the plurality of first tasks is associated with instructing a NIC (e.g., hardware device 604) to deliver a packet (e.g., workflow tasks), and wherein each second task of the plurality of second tasks instructs the NIC to log a timestamp in response to an event associated with a respective first task (e.g., timestamp logging tasks).

The host 602 provides the hardware device 604 access to the traceable work descriptor at 608. Continuing the previous example, the NIC fetches the traceable work descriptor upon receiving access and proceeds to decode the traceable work descriptor and begin executing the plurality of first tasks of the work descriptor at 610. In at least one embodiment, providing the NIC access to the traceable work descriptor includes storing the traceable work descriptor in a work queue of the host system accessible by the NIC.

The plurality of first tasks associated with instructing the NIC to deliver the packet may include at least one of reading the traceable work descriptor, fetching data of the packet from the host system, storing the data of the packet in an internal memory of the NIC, attaching a packet header to the packet data, encrypting the packet, sending the data of the packet to a wire of the NIC, or other relevant tasks. Once the NIC begins executing a first task, a series of hardware events 612A-n associated with these examples are triggered in sequence. For example, hardware event 612A may correspond to fetching data of the packet from the host system, hardware event 612B may correspond to storing the data of the packet in an internal memory of the NIC, and the final hardware event 612N may correspond to sending the data of the packet to a wire of the NIC. The second tasks instruct the NIC to log timestamps in response to these events, and each second task of the plurality of second tasks may further instruct the NIC to associate a unique identifier to the respective first task and/or an event label to the respective hardware event.

In at least one embodiment, the NIC collects the timestamp logs locally, such as in timestamp log buffer 124 of FIG. 1. The NIC may forward these logs at 614 such that the host system receives a timestamp according to each second task of the plurality of second tasks in a single transaction. In another embodiment, the NIC may send intermediate logs 616A-n periodically during the execution sequence, such that each intermediate log comprises a single timestamp log or a subset of timestamp logs. For example, the NIC may send, for each traceable work descriptor, a first log comprising one or more timestamp logs to completion endpoint 110 of FIG. 1 at a first time, a second log comprising one or more timestamp logs at a second time, and so on until the work descriptor is complete and all timestamp logs have been sent.

FIG. 7 is a block diagram illustrating an example computer system 700 in accordance with at least some embodiments. In at least one embodiment, computer system 700 may be a system with interconnected devices and components, a System on Chip (SoC), or some combination. In at least one embodiment, computer system 700 is formed with a processor 702 that may include execution units to execute an instruction. In at least one embodiment, computer system 700 may include, without limitation, a component, such as a processor 702, to employ execution units including logic to perform algorithms for processing data. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 700 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 700 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 700 may include, without limitation, processor 702 that may include, without limitation, one or more execution units 708 that may be configured to process traceable work descriptors and/or perform on-demand hardware event logging according to techniques described herein. In at least one embodiment, computer system 700 is a single processor desktop or server system. In at least one embodiment, computer system 700 may be a multiprocessor system. In at least one embodiment, processor 702 may include, without limitation, a complex instruction set computer (CISC) microprocessor, a reduced instruction set computer (RISC) microprocessor, a Very Long Instruction Word (VLIW) microprocessor, and a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. In at least one embodiment, processor 702 may also include a combination of both internal and external caches. In at least one embodiment, a register file 706 may store different types of data in various registers, including integer registers, floating point registers, status registers, instruction pointer registers, or the like.

In at least one embodiment, execution unit 708, including, without limitation, logic to perform integer and floating-point operations, also resides in processor 702. Processor 702 may also include a microcode (“ucode”) read-only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor 702, along with associated circuitry to execute instructions, operations used by many multimedia applications may be performed using packed data in a general-purpose processor 702. In at least one embodiment, many multimedia applications may be accelerated and executed more efficiently by using the full width of a processor's data bus for performing operations on packed data, which may eliminate the need to transfer smaller units of data across a processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be implemented as a Dynamic Random Access Memory (DRAM) device, a Static Random Access Memory (SRAM) device, a flash memory device, or other memory devices. Memory 720 may store instruction(s) 719 and/or data 721 represented by data signals that may be executed by processor 702.

In at least one embodiment, a system logic chip may be coupled to a processor bus 710 and memory 720. In at least one embodiment, the system logic chip may include, without limitation, a memory controller hub (“MCH”) 716, and processor 702 may communicate with MCH 716 via processor bus 710. In at least one embodiment, MCH 716 may provide a high bandwidth memory path to memory 720 for instruction and data storage and for storage of graphics commands, data, and textures. In at least one embodiment, MCH 716 may direct data signals between processor 702, memory 720, and other components in computer system 700 and may bridge data signals between processor bus 710, memory 720, and a system I/O 722. In at least one embodiment, a system logic chip may provide a graphics port for coupling to a graphics controller. In at least one embodiment, MCH 716 may be coupled to memory 720 through high bandwidth memory path, and graphics/video card 712 may be coupled to MCH 716 through an Accelerated Graphics Port (“AGP”) interconnect 714.

In at least one embodiment, computer system 700 may use system I/O 722, which can be a proprietary hub interface bus to couple MCH 716 to I/O controller hub (“ICH”) 730. In at least one embodiment, ICH 730 may provide direct connections to some I/O devices via a local I/O bus. In at least one embodiment, a local I/O bus may include, without limitation, a high-speed I/O bus for connecting peripherals to memory 720, a chipset, and processor 702. Examples may include, without limitation, an audio controller 729, a firmware hub (“flash BIOS”) 728, a wireless transceiver 726, a data storage 724, a legacy I/O controller 723 containing a user input interface 725, a keyboard interface, a serial expansion port 727, such as a USB port, and a network controller 734, which may include in some embodiments, a data processing unit. Data storage 724 may comprise a hard disk drive, a floppy disk drive, a CD-ROM device, a flash memory device, or other mass storage devices.

In at least one embodiment, FIG. 7 illustrates a computer system 700, which includes interconnected hardware devices or “chips.” In at least one embodiment, FIG. 7 may illustrate an example SoC. In at least one embodiment, devices illustrated in FIG. 7 may be interconnected with proprietary interconnects, standardized interconnects (e.g., Peripheral Component Interconnect Express (PCIe), or some combination thereof. In at least one embodiment, one or more components of computer system 700 are interconnected using compute express link (“CXL”) interconnects.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A. C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more individual non-transitory storage media of multiple non-transitory computer-readable storage media lacks all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes for continuously or intermittently carrying out instructions in sequence or parallel. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating, by a host system, a work descriptor identifying a plurality of workflow tasks to be performed by a hardware device;
adding a plurality of timestamp logging tasks to the work descriptor, wherein each of the plurality of timestamp logging tasks corresponds to one of the plurality of workflow tasks and instructs the hardware device to log a timestamp in response to an event associated with a respective workflow task; and
storing the work descriptor with the plurality of timestamp logging tasks in a work queue of the host system, wherein the work queue is accessible by the hardware device.

2. The method of claim 1, further comprising:
associating each timestamp logging task with a respective workflow task based on user input.

3. The method of claim 2, wherein each of the plurality of timestamp logging tasks further instructs the hardware device to log, in response to the event associated with the respective workflow task, a unique identifier associated with the respective workflow task to a log.

4. The method of claim 1, further comprising:
notifying the hardware device about the work descriptor in the work queue.

5. The method of claim 4, wherein the hardware device is to access the work descriptor in the work queue upon receiving a notification.

6. The method of claim 1, wherein the hardware device is one of: a network interface controller, a graphics processing unit, a data processing unit, or a central processing unit.

7. The method of claim 1, further comprising:
receiving, by the host system, a first log comprising a first plurality of timestamps logged by the hardware device according to the plurality of timestamp logging tasks for events associated with workflow tasks.

8. The method of claim 7, wherein the timestamps logged by the hardware device according to the plurality of timestamp logging tasks for events associated with workflow tasks are grouped based on the work descriptor.

9. The method of claim 7, wherein the timestamps logged by the hardware device according to the plurality of timestamp logging tasks for events associated with workflow tasks correspond to a plurality of distributed clocks on the hardware device, each distributed clock of the plurality of distributed clocks being spatially proximal to hardware associated with an event of the events associated with workflow tasks.

10. The method of claim 7, further comprising:
receiving, by the host system, a second log comprising a second plurality of timestamps logged by the hardware device according to the plurality of timestamp logging tasks for events associated with workflow tasks.

11. The method of claim 1, further comprising:
periodically using a plurality of timestamps logged by the hardware device to obtain latency related statistical information of the hardware device.

12. The method of claim 1, wherein the event associated with the respective workflow task is one of: a breakpoint event, an initiation event of a stage of the respective workflow task, a completion event of the stage of the respective workflow task, or a completion event of the respective workflow task.

13. A system comprising:
one or more processing units to
generate, by a host system, a work descriptor identifying a plurality of workflow tasks to be performed by a hardware device;
add a plurality of timestamp logging tasks to the work descriptor, wherein each of the plurality of timestamp logging tasks corresponds to one of the plurality of workflow tasks and instructs the hardware device to log a timestamp in response to an event associated with a respective workflow task; and
store the work descriptor with the plurality of timestamp logging tasks in a work queue of the host system accessible by the hardware device.

14. The system of claim 13, wherein the one or more processing units further to:
associate each timestamp logging task with a respective workflow task based on user input.

15. The system of claim 13, wherein the one or more processing units further to:
notify the hardware device about the work descriptor in the work queue.

16. The system of claim 13, wherein the one or more processing units further to:
Receive, by the host system, a log comprising timestamps logged by the hardware device according to the plurality of timestamp logging tasks for events associated with workflow tasks.

17. A non-transitory computer-readable storage medium comprising instructions that, when executed by a processing device, cause the processing device to perform operations comprising:
generating, by a host system, a traceable work descriptor, wherein the traceable work descriptor comprises a plurality of first tasks and a plurality of second tasks, wherein the plurality of first tasks is associated with instructing a network interface controller (NIC) to deliver a packet, and wherein each second task of the plurality of second tasks instructs the NIC to log a timestamp in response to an event associated with a respective first task;
providing the NIC access to the traceable work descriptor; and
receiving, by the host system, a timestamp according to each second task of the plurality of second tasks.

18. The non-transitory computer-readable storage medium of claim 17, wherein each second task of the plurality of second tasks further instructs the NIC, in response to the event associated with the respective first task, to associate a unique identifier to the respective first task.

19. The non-transitory computer-readable storage medium of claim 17, wherein providing the NIC access to the traceable work descriptor includes storing the traceable work descriptor in a work queue of the host system accessible by the NIC.

20. The non-transitory computer-readable storage medium of claim 17, wherein the plurality of first tasks associated with instructing the NIC to deliver the packet includes at least one of: reading, by the NIC, the traceable work descriptor; fetching, by the NIC, data of the packet from the host system; storing, by the NIC, the data of the packet in an internal memory of the NIC; or sending, by the NIC, the data of the packet to a wire of the NIC.
